(19) United States
(12) Patent Application Publication
(10) Pub. No.: US 2024/0034087 A1
(43) Pub. Date: Feb. 1, 2024

(54) THERMAL TRANSFER SHEET, COMBINATION OF THERMAL TRANSFER SHEET AND TRANSFER-RECEIVING ARTICLE, METHOD FOR PRODUCING THERMAL TRANSFER SHEET, AND METHOD FOR PRODUCING TRANSFER PRODUCT

(71) Applicant: DAI NIPPON PRINTING CO., LTD., Tokyo (JP)

(72) Inventors: Megumi IKEDA, Tokyo (JP); Ryoji HATTORI, Tokyo (JP)

(73) Assignee: DAI NIPPON PRINTING CO., LTD., Tokyo (JP)

(21) Appl. No.: 18/254,217

(22) PCT Filed: Nov. 26, 2021
(86) PCT No.: PCT/JP2021/043386

§ 371 Date: May 24, 2023

(30) Foreign Application Priority Data
Nov. 26, 2020 (JP) 2020-196278

(51) Int. Cl. B41M 5/42

(52) U.S. Cl. CPC B41M 5/426

(57) ABSTRACT

A thermal transfer sheet including a substrate and a transfer layer on the substrate in this order in the thickness direction, the transfer layer being peelable by thermal transfer, wherein the transfer layer includes an electrically conductive layer or metal-containing layer and an adhesive layer, the adhesive layer contains at least one component selected from a modified polyolefin and an ionomer, and the electrically conductive layer or the metal-containing layer constitutes a surface layer on the substrate side of the transfer layer.

### TECHNICAL FIELD

The present disclosure relates to a thermal transfer sheet, a combination of a thermal transfer sheet and a transfer-receiving article, a method for producing a thermal transfer sheet, and a method for producing a transfer product.

### BACKGROUND ART

A known method for producing a transfer product includes using a thermal transfer sheet including a transfer layer including an electrically conductive layer to transfer and form an electrically conductive layer, such as an antenna wire, on a transfer-receiving article. Patent Literature 1 discloses a transfer film for forming an antenna circuit in which a release layer, a thin metal film layer, and an adhesive layer are sequentially formed on one surface of a plastic film.

### CITATION LIST

### Patent Literature

PTL 1: JP 2006-324732 A1

### SUMMARY OF INVENTION

### Technical Problem

When a transfer layer including an electrically conductive layer is transferred from a thermal transfer sheet onto a transfer-receiving article, the transfer layer may be insufficiently transferred and cause blurring, or even the transfer layer in a nontransfer region adjacent to the thermal transfer region may be transferred (that is, tailing may occur). In particular, such a phenomenon is likely to occur on a transfer-receiving article with low surface smoothness. Thus, a transfer layer including an electrically conductive layer is required to have high transferability. Such high transferability is also required for a transfer layer including a metal-containing layer.

A transfer-receiving article of the present disclosure is to provide a thermal transfer sheet including a transfer layer including an electrically conductive layer or a metal-containing layer, wherein the transfer layer has high transferability to a transfer-receiving article with low smoothness.

A transfer-receiving article of the present disclosure is to provide a combination of the thermal transfer sheet and a transfer-receiving article, a method for producing the thermal transfer sheet, and a method for producing a transfer product using the thermal transfer sheet.

### Solution to Problem

A thermal transfer sheet according to the present disclosure includes a substrate and a transfer layer on the substrate in this order in the thickness direction, the transfer layer being peelable by thermal transfer. The transfer layer includes an electrically conductive layer or metal-containing layer and an adhesive layer. The adhesive layer contains at least one component selected from a modified polyolefin and an ionomer. The electrically conductive layer or the metal-containing layer constitutes a surface layer on the substrate side of the transfer layer.

A combination in the present disclosure is a combination of the thermal transfer sheet and a transfer-receiving article.

A method for producing a thermal transfer sheet according to the present disclosure includes the steps of preparing a substrate and forming a transfer layer on the substrate, the transfer layer including an electrically conductive layer or metal-containing layer and an adhesive layer. The adhesive layer contains at least one component selected from a modified polyolefin and an ionomer. The electrically conductive layer or the metal-containing layer constitutes a surface layer on the substrate side of the transfer layer.

A method for producing a transfer product according to the present disclosure includes the steps of preparing the thermal transfer sheet and a transfer-receiving article and thermally transferring a transfer layer of the thermal transfer sheet onto the transfer-receiving article.

### Advantageous Effects of Invention

The present disclosure can provide a thermal transfer sheet including a transfer layer including an electrically conductive layer or a metal-containing layer, wherein the transfer layer has high transferability to a transfer-receiving article with low smoothness. The present disclosure can provide a combination of the thermal transfer sheet and a transfer-receiving article, a method for producing the thermal transfer sheet, and a method for producing a transfer product using the thermal transfer sheet.

### BRIEF DESCRIPTION OF DRAWINGS

FIG. 1 is a schematic cross-sectional view of an embodiment of a thermal transfer sheet according to the present disclosure.

FIG. 2 is a schematic cross-sectional view of an embodiment of a thermal transfer sheet according to the present disclosure.

FIG. 3 is a schematic cross-sectional view of an embodiment of a thermal transfer sheet according to the present disclosure.

### DESCRIPTION OF EMBODIMENTS

[Thermal Transfer Sheet]

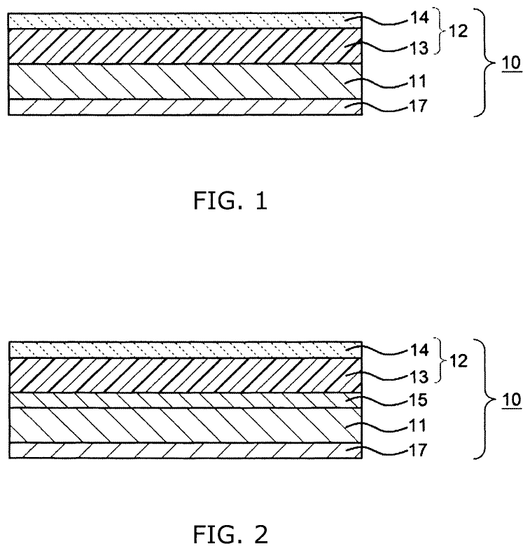

As illustrated in FIG. 1, a thermal transfer sheet 10 according to the present disclosure includes a substrate 11 and a transfer layer 12 on the substrate 11 in this order in the thickness direction, the transfer layer 12 being peelable by thermal transfer. The transfer layer 12 includes an electrically conductive layer or metal-containing layer 13 and an adhesive layer 14 in this order in the thickness direction of the thermal transfer sheet 10. The electrically conductive layer or metal-containing layer 13 constitutes a surface layer of the transfer layer 12 on the side of the substrate 11.

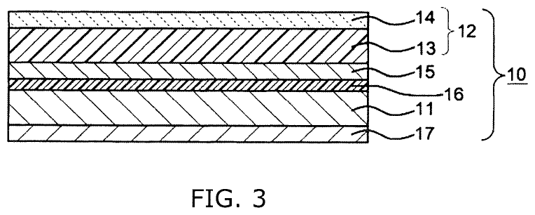

In one embodiment, as illustrated in FIG. 2, the thermal transfer sheet 10 includes a release layer 15 between the substrate 11 and the transfer layer 12. In one embodiment, as illustrated in FIG. 3, the thermal transfer sheet 10 includes an anchor coat layer 16 between the substrate 11 and the release layer 15.

In one embodiment, as illustrated in FIGS. 1, 2, and 3, the thermal transfer sheet 10 includes a back layer 17 on the surface of the substrate 11 opposite the transfer layer 12.

Each layer of a thermal transfer sheet according to the present disclosure is described below.

<Substrate>

The substrate can be any substrate that has heat resistance to thermal energy applied during thermal transfer, has mechanical strength to support a transfer layer and the like on the substrate, and has solvent resistance.

The substrate can be, for example, a film formed of a resin material (hereinafter also referred to simply as a “resin film”). Examples of the resin material include polyesters, such as poly(ethylene terephthalate) (PET), poly(butylene terephthalate) (PBT), poly(ethylene naphthalate) (PEN), 1,4-poly(cyclohexylene dimethylene terephthalate), and terephthalic acid-cyclohexanedimethanol-ethylene glycol copolymers; polyamides, such as nylon 6 and nylon 6,6; polyolefins, such as polyethylene (PE), polypropylene (PP) and polymethylpentene; vinyl resins, such as poly(vinyl chloride), poly(vinyl alcohol) (PVA), poly(vinyl acetate), vinyl chloride-vinyl acetate copolymers, and polyvinylpyrrolidone (PVP); vinyl acetal resins, such as poly(vinyl acetoacetal) and poly(vinyl butyral); (meth)acrylic resins, such as poly(meth)acrylate; imide resins, such as polyimides and poly(ether imide); cellulose resins, such as cellophane, cellulose acetate, nitrocellulose, cellulose acetate propionate (CAP), and cellulose acetate butyrate (CAB); styrene resins, such as polystyrene (PS); polycarbonates; and ionomers.

Among these resin materials, in terms of heat resistance and mechanical strength, polyesters are preferred, PET or PEN is more preferred, and PET is still more preferred.

In the present disclosure, “(meth)acryl” encompasses both “acryl” and “methacryl”, and “(meth)acrylate” encompasses both “acrylate” and “methacrylate”.

The substrate can also be a laminate of the resin films. A laminate of the resin films can be formed, for example, by a dry lamination method, a wet lamination method, or an extrusion method.

The resin film may be an oriented film or an unoriented film, and an uniaxially or biaxially oriented film is preferred in terms of strength.

The substrate preferably has a thickness of 1 μm or more and 50 μm or less, more preferably 3 μm or more and 25 μm or less. This can improve the mechanical strength of the substrate and thermal energy transfer during thermal transfer.

<Release Layer>

In one embodiment, a thermal transfer sheet according to the present disclosure includes a release layer between the substrate and the transfer layer. The release layer is a layer for improving the peelability of the transfer layer on the substrate. The release layer is a layer that does not constitute the transfer layer and is a layer that remains on the substrate side when the transfer layer is transferred onto a transfer-receiving article.

The release layer may be composed of any resin material that has high adhesiveness to the substrate and has appropriate peelability with which the transfer layer can be easily peeled. Examples of such a resin material include silicone resins, fluoropolymers, poly(vinyl alcohol), (meth)acrylic resins, thermally crosslinkable epoxy-amino resins, thermally crosslinkable alkyd-amino resins, melamine resins, cellulose resins, urea resins, polyolefins, and waxes. Among these, silicone resins are preferred because the silicone resins can improve the transferability of the transfer layer and, for example, can form an electrically conductive layer with high electrical conductivity or a metal-containing layer with high specular gloss.

The release layer can contain one or two or more of the resin materials.

In the present disclosure, the silicone resins are resins with a siloxane bond in their molecular structures and include unmodified polysiloxanes, modified polysiloxanes, and silicone-modified resins. In the present disclosure, the silicone resins include resins produced by curing a raw material silicone in the presence of a curing catalyst or the like.

The term “polysiloxane” refers to a resin with a main chain composed of a siloxane bond.

The term “silicone-modified resin” refers to, for example, a polymer of a monomer with a polysiloxane group and another monomer, that is, a resin with a side chain composed of a siloxane bond. Examples thereof include silicone-modified (meth)acrylic resins.

In one embodiment, a silicone resin has monofunctional (R₃SiO_{1/2})ₙ, bifunctional (R₂SiO)ₙ, trifunctional (RSiO_{3/2})ₙ, or tetrafunctional (SiO₂)ₙ as a basic structural unit.

Preferably, a silicone resin is at least one selected from silsesquioxanes with trifunctional (RSiO_{3/2})ₙ as a basic structural unit and cured products thereof. This can further improve the transferability, such as the foil release, of the transfer layer.

The phrase “the foil release of the transfer layer”, as used herein, refers to the degree of suppression of tailing when the transfer layer is transferred onto a transfer-receiving article. Good foil release means that the occurrence of tailing can be reduced. The improvement of the foil release can reduce the decrease in electrical conductivity of the electrically conductive layer, make the thickness of the electrically conductive layer uniform, and improve the holding property of the electrically conductive layer. Furthermore, the improvement of the foil release can make the thickness of the metal-containing layer uniform and improve the holding property of the metal-containing layer.

The silsesquioxanes may have a random structure, a complete cage structure, an incomplete cage structure, or a ladder structure. Among these, silsesquioxanes with a random structure are preferred in terms of foil release.

In the basic structural unit, R denotes an organic group, and the organic group may have a substituent. The substituent is, for example, an epoxy group, a hydroxy group, an amino group, or a mercapto group. Among these, an epoxy group is preferred. This can further improve the transferability, such as the foil release, of the transfer layer.

In the basic structural unit, n is an integer of 2 or more.

In one embodiment, the silicone resin is a silicone-modified resin with a siloxane bond as a cross-link. A preferred example of the resin is a resin produced by curing a resin with an alkoxysilyl group in the presence of a curing catalyst or the like (a cured product). In one embodiment, the cured product is a resin produced by subjecting two or more alkoxysilyl groups of the resin with an alkoxysilyl group to hydrolysis and a silanol reaction to form a cross-linked structure “Si—O—Si”. In one embodiment, the cured product is a resin produced by a resin with an alkoxysilyl group and another compound forming a cross-linked structure “Si—O—Si”.

Examples of the resin with an alkoxysilyl group include (meth)acrylic resins with an alkoxysilyl group, polyesters with an alkoxysilyl group, epoxy resins with an alkoxysilyl group, alkyd resins with an alkoxysilyl group, fluoropolymers with an alkoxysilyl group, urethane resins with an alkoxysilyl group, phenolic resins with an alkoxysilyl group, and melamine resins with an alkoxysilyl group. Among these, (meth)acrylic resins with an alkoxysilyl group are preferred in terms of the transferability, such as the foil release, of the transfer layer.

Examples of the alkoxysilyl group include a trialkoxysilyl group, a dimethoxysilyl group, and a monoalkoxysilyl group.

The release layer preferably has a silicone resin content of 50% by mass or more and 99.5% by mass or less, more preferably 70% by mass or more and 98% by mass or less. This can further improve the transferability, such as the foil release, of the transfer layer.

In one embodiment, the release layer contains a curing catalyst. This can further improve the transferability, such as the foil release, of the transfer layer. Examples of the curing catalyst include aluminum catalysts, tin catalysts, titanium catalysts, and zirconia catalysts.

The release layer preferably has a curing catalyst content of 0.5 parts by mass or more and 20 parts by mass or less, more preferably 3 parts by mass or more and 15 parts by mass or less, per 100 parts by mass of the silicone resin. This can further improve the transferability, such as the foil release, of the transfer layer.

In one embodiment, the release layer contains one or two or more resin materials (other resin materials) other than the silicone resin. Examples of the other resin materials include polyesters, polyamides, polyolefins, vinyl resins, vinyl acetal resins, (meth)acrylic resins, imide resins, cellulose resins, styrene resins, polycarbonates, and ionomers.

The release layer may contain one or two or more additive agents. Examples of the additive agents include filler, a plasticizer, an antistatic agent, an ultraviolet absorber, organic particles, inorganic particles, a release agent, and a dispersant.

The release layer preferably has a thickness of 0.1 μm or more and 3.0 μm or less, more preferably 0.3 μm or more and 2.0 μm or less. This can further improve the transferability, such as the foil release, of the transfer layer.

The release layer can be formed, for example, by dispersing or dissolving the above components in water or an appropriate organic solvent to prepare a coating liquid, applying the coating liquid to a substrate or an anchor coat layer to form a coating film, and drying the coating film. The application method is, for example, a known method, such as a roll coating method, a reverse roll coating method, a gravure coating method, a reverse gravure coating method, a bar coating method, or a rod coating method. Heating the coating film after drying can, for example, effectively promote the curing of the silicone resin and further improve the transferability of the transfer layer.

<Transfer Layer>

The transfer layer is peelably provided on the substrate. In one embodiment, the transfer layer is peelably provided on the substrate via the release layer. The transfer layer includes an electrically conductive layer or metal-containing layer and an adhesive layer in this order in the thickness direction of the thermal transfer sheet.

(Electrically Conductive Layer and Metal-Containing Layer)

In a thermal transfer sheet according to the present disclosure, the electrically conductive layer or the metal-containing layer constitutes a surface layer on the substrate side of the transfer layer. In a thermal transfer sheet according to an embodiment of the present disclosure, the electrically conductive layer or the metal-containing layer is provided in contact with the release layer.

In one embodiment, the electrically conductive layer transferred and formed using the thermal transfer sheet is required to have high electrical conductivity. In known thermal transfer sheets, however, a transfer layer including an electrically conductive layer does not have sufficiently high transferability to a transfer-receiving article with low surface smoothness, and the electrically conductive layer transferred and formed does not have sufficiently high electrical conductivity on the transfer-receiving article. When a transfer layer including an electrically conductive layer is provided with a separation layer as a layer closest to a substrate, the separation layer is present on the electrically conductive layer on the surface of the transfer layer transferred and formed, so that desired electrical conductivity is not necessarily achieved. Removal of the separation layer after the transfer increases the number of steps and increases the cost.

In one embodiment, a thermal transfer sheet according to the present disclosure includes a transfer layer which includes an electrically conductive layer and an adhesive layer containing a specific component, wherein the electrically conductive layer constitutes a surface layer on the substrate side of the transfer layer. In such a thermal transfer sheet, the transfer layer has high transferability to a transfer-receiving article with low smoothness, and the electrically conductive layer with high electrical conductivity can be transferred and formed.

For example, when the transfer layer is transferred onto a transfer-receiving article using the thermal transfer sheet, the electrically conductive layer (electrically conductive pattern layer) thus formed constitutes a surface layer (outermost layer) of the transfer product. Thus, the transferred electrically conductive layer has high electrical conductivity.

In one embodiment, the metal-containing layer transferred and formed using the thermal transfer sheet is required to have high specular gloss of the metal. In known thermal transfer sheets, however, a transfer layer including a metal-containing layer does not have sufficiently high transferability to a transfer-receiving article with low surface smoothness, and the metal-containing layer transferred and formed does not have sufficiently high specular gloss on the transfer-receiving article. For example, a metal-containing layer with low transferability (adhesiveness) to a transfer-receiving article with low smoothness may cause a space between the transfer-receiving article and the metal-containing layer, roughen the surface, and have reduced specular gloss.

In one embodiment, a thermal transfer sheet according to the present disclosure includes a transfer layer, which includes a metal-containing layer and an adhesive layer containing a specific component, wherein the metal-containing layer constitutes a surface layer on the substrate side of the transfer layer. In such a thermal transfer sheet, the transfer layer has high transferability to a transfer-receiving article with low smoothness, and the metal-containing layer with high specular gloss can be transferred and formed.

For example, when the transfer layer is transferred onto a transfer-receiving article using the thermal transfer sheet, the metal-containing layer thus formed constitutes a surface layer (outermost layer) of the transfer product. Thus, the transferred metal-containing layer has high specular gloss.

The electrically conductive layer is, for example, a metallized layer or an electrically conductive polymer layer. The electrically conductive layer may also be a layer formed by using a graphene paint, a carbon nanotube paint, a carbon black paint, or an electrically conductive paint containing an electrically conductive oxide or metal particles. The electrically conductive layer may be a metal-pigment-containing layer described later, provided that the metal-pigment-containing layer has electrical conductivity. Among these electrically conductive layers, a metallized layer is preferred in terms of the transferability, such as the foil release, of the transfer layer.

The metallized layer can be formed of a metal, such as aluminum, silver, copper, zinc, silicon, magnesium, calcium, potassium, tin, sodium, titanium, lead, indium, or zirconium. Among these, an aluminum-deposited layer and a copper-deposited layer are preferred.

The metallized layer preferably has a thickness of 5 nm or more and 500 nm or less, more preferably 25 nm or more and 400 nm or less, still more preferably 30 nm or more and 350 nm or less. This can further improve the transferability, such as the foil release, of the transfer layer.

The metallized layer may be formed by a physical vapor deposition method (PVD method), such as a vacuum deposition method, a sputtering method, or an ion plating method; or a chemical vapor deposition method (CVD method), such as a plasma chemical vapor deposition method, a thermal chemical vapor deposition method, or a photochemical vapor deposition method.

The electrically conductive polymer layer contains one or two or more electrically conductive polymers. Examples of the electrically conductive polymer include polythiophene, polypyrrole, polyaniline, poly(phenylene vinylene), polyphenylene, polyacetylene, polyquinoxaline, polyoxadiazole, polybenzothiadiazole, and polymers with a plurality of these electrically conductive skeletons.

The electrically conductive polymer layer is formed, for example, by applying a coating liquid of the electrically conductive polymer to the release layer by a wet coating method, such as a flexographic printing method, a screen printing method, a bar coating method, a spin coating method, a casting method, a die coating method, a gravure coating method, a spray coating method, or an ink jet method, and if necessary drying the coating liquid.

The electrically conductive polymer layer preferably has a thickness of 0.01 μm or more and 10.0 μm or less, more preferably 0.05 μm or more and 5.0 μm or less, still more preferably 0.1 μm or more and 2.0 μm or less.

The metal-containing layer is, for example, a metal-pigment-containing layer. The metal-containing layer may be a metal-containing nonconductive layer or a metal-containing electrically conductive layer. The metal-containing electrically conductive layer may be an electrically conductive layer, such as the metallized layer described above. In one embodiment, the metal-containing layer is a metal-pigment-containing nonconductive layer.

The metal-pigment-containing layer contains one or two or more metal pigments. Examples of the metal pigments include particles of aluminum, nickel, chromium, brass, tin, brass, bronze, zinc, silver, platinum, gold, oxides thereof, and metallized glass. Among these, aluminum pigments are preferred to further improve the transferability of the metal-pigment-containing layer and the gloss of a transfer product.

The aluminum pigments may be of a leafing type or a non-leafing type. Aluminum pigments of the non-leafing type are preferred to further improve the transferability of the metal-pigment-containing layer and the gloss of a transfer product.

The metal pigments preferably have a median diameter (D50) of 1 μm or more and 10 μm or less, more preferably 4 μm or more and 8 μm or less. This can improve the fine-line printability of the thermal transfer sheet. In the present disclosure, the median diameter (D50) of a metal pigment is measured in accordance with JIS Z 8825: 2013.

The metal pigment preferably has a hiding power of 2 or more, more preferably 2.5 or more. This can effectively hide and suppress the hue of a transfer-receiving article from affecting the hue of an image in a transfer product. The metal pigment preferably has a hiding power of 6 or less, more preferably 5.5 or less. In the present disclosure, the hiding power of a metal pigment is measured in accordance with JIS K 5600-4-1.

The metal-pigment-containing layer preferably has a metal pigment content of 23% by mass or more and 83% by mass or less, more preferably 33% by mass or more and 67% by mass or less. This can further improve the transferability of the metal-pigment-containing layer and the gloss of a transfer product produced using the thermal transfer sheet.

The metal-pigment-containing layer may contain one or two or more resin materials. Examples of the resin materials include polyesters, polyamides, polyolefins, vinyl resins, (meth)acrylic resins, cellulose resins, styrene resins, polycarbonates, and ionomer resins. Among these, to further improve the transferability and fine-line printability of the metal-pigment-containing layer, polyesters, vinyl resins, and (meth)acrylic resins are preferred, and vinyl resins and (meth)acrylic resins are more preferred.

The metal-pigment-containing layer preferably has a resin material content of 17% by mass or more and 77% by mass or less, more preferably 33% by mass or more and 67% by mass or less. This can further improve the transferability of the metal-pigment-containing layer.

The ratio of the metal pigment content to the resin material content (PV ratio=metal pigment content/resin material content) of the metal-pigment-containing layer is preferably 0.3 or more and 5 or less, more preferably 0.5 or more and 2 or less. This can further improve the transferability of the metal-pigment-containing layer and the gloss of a transfer product produced using the thermal transfer sheet.

The metal-pigment-containing layer may contain one or two or more additive agents. Examples of the additive agents include filler, a plasticizer, an antistatic agent, an ultraviolet absorber, inorganic particles, organic particles, a release agent, and a dispersant.

The metal-pigment-containing layer preferably has a thickness of 0.1 μm or more and 7.0 μm or less, more preferably 0.2 μm or more and 4.5 μm or less. This can improve the fine-line printability of the metal-pigment-containing layer.

In one embodiment, the metal-pigment-containing layer may have a 45-degree specular gloss of 30% or more and 65% or less. This can improve the transferability of the metal-pigment-containing layer and the gloss of a transfer product produced using the thermal transfer sheet.

The 45-degree specular gloss of the metal-pigment-containing layer is a value measured in the metal-pigment-containing layer of the transfer layer transferred to a transfer-receiving article. In the present disclosure, the 45-degree specular gloss of the metal-pigment-containing layer is measured with a gloss meter in accordance with 45-degree Specular glossiness-Methods of measurement described in JIS Z 8741.

The 45-degree specular gloss can be adjusted, for example, by the metal pigment content, the median diameter and surface smoothness, and the thickness of the metal-pigment-containing layer. More specifically, the gloss tends to increase with the metal pigment content of the metal-pigment-containing layer, with the median diameter of the metal pigment, and with the surface smoothness of the metal pigment, and tends to decrease with the increasing thickness of the metal-pigment-containing layer.

The metal-pigment-containing layer can be formed, for example, by dispersing or dissolving the above components in water or an appropriate organic solvent to prepare a coating liquid, applying the coating liquid by the coating method described above to a substrate or the release layer to form a coating film, and drying the coating film.

(Adhesive Layer)

The adhesive layer contains at least one component selected from a modified polyolefin and an ionomer. In one embodiment, the adhesive layer constitutes an outer surface layer of the transfer layer and is a layer that comes into contact with a transfer-receiving article when the transfer layer is transferred to the transfer-receiving article. In one embodiment, the adhesive layer is a layer in contact with the electrically conductive layer or the metal-containing layer.

The adhesive layer contains the components described above, and, although the reason is not clear, a thermal transfer sheet according to the present disclosure has high transferability and fine-line reproducibility even on a transfer-receiving article with low smoothness described later, and the electrically conductive layer or the metal-containing layer transferred and formed has fewer cracks. In one embodiment, the electrically conductive layer has high electrical conductivity, and the metal-containing layer has high specular gloss. These advantages are particularly noticeable on a transfer-receiving article with a smoothness of 1700 seconds or more or 2000 seconds or more described later.

The adhesive layer containing at least one component selected from a modified polyolefin and an ionomer has high adhesiveness to both an electrically conductive layer, such as a metallized layer, or a metal-containing layer, such as a metal-pigment-containing layer, and a transfer-receiving article, such as a paper substrate.

Examples of the modified polyolefins include a copolymer of an olefin and a polar monomer, and a graft-modified product of a polyolefin or the copolymer modified with a polar monomer. Among these, a copolymer of an olefin and a polar monomer is preferred.

In the copolymer of an olefin and a polar monomer, the olefin is, for example, ethylene, an α-olefin with 3 or more and 20 or less carbon atoms, or a cyclic olefin, preferably ethylene or an α-olefin with 3 or more and 20 or less carbon atoms, more preferably ethylene or an α-olefin with 3 or more and 10 or less carbon atoms, still more preferably ethylene or propylene. The olefins may be used alone or in combination.

Examples of the α-olefin with 3 or more and 20 or less carbon atoms include propylene, 1-butene, 4-methyl-1-pentene, 3-methyl-1-butene, 1-hexene, 1-octene, and 1-decene. Examples of the cyclic olefin include tetracyclododecene and norbornene.

Examples of the polar monomer include unsaturated carboxylic acids and derivatives thereof, and vinyl esters, such as vinyl acetate, vinyl propionate, and vinyl pivalate. The polar monomers may be used alone or in combination.

Examples of the unsaturated carboxylic acids include (meth)acrylic acid, maleic acid, fumaric acid, tetrahydrophthalic acid, itaconic acid, citraconic acid, crotonic acid, isocrotonic acid, norbornene dicarboxylic acid, and bicyclo[2.2.1]hept-2-en-5,6-dicarboxylic acid. Among these, (meth)acrylic acid is preferred.

Examples of the derivatives of unsaturated carboxylic acids include acid anhydrides, acid halides, amides, imides, esters, and salts of the unsaturated carboxylic acids. Examples of the derivatives include maleic anhydride, itaconic anhydride, citraconic anhydride, tetrahydrophthalic anhydride, bicyclo[2.2.1]hept-2-en-5,6-dicarboxylic anhydride, malonyl chloride, acrylamide, methacrylamide, malonyl imide, dimethyl maleate, monomethyl maleate, diethyl maleate, monoethyl maleate, diethyl fumarate, dimethyl itaconate, diethyl citraconate, dimethyl tetrahydrophthalate, dimethyl bicyclo[2.2.1]hept-2-en-5,6-dicarboxylate, alkyl (meth)acrylates, hydroxyethyl (meth)acrylate, hydroxypropyl (meth)acrylate, glycidyl (meth)acrylate, and ammonium salts and amine salts of unsaturated carboxylic acids.

Specific examples of the copolymer of an olefin and a polar monomer include ethylene-(meth)acrylic acid copolymers, ethylene-alkyl (meth)acrylate copolymers, propylene-(meth)acrylic acid copolymers, propylene-alkyl (meth)acrylate copolymers, and ethylene-vinyl acetate copolymers. Among these, ethylene-(meth)acrylic acid copolymers, propylene-(meth)acrylic acid copolymers, and ethylene-vinyl acetate copolymers are preferred.

These copolymers may be neutralized salts, such as ammonium salts or amine salts.

In the copolymer of an olefin and a polar monomer, a constitutional unit derived from the olefin preferably constitutes 20% by mass or more and 90% by mass or less, more preferably 50% by mass or more and 80% by mass or less; and a constitutional unit derived from the polar monomer preferably constitutes 10% by mass or more and 80% by mass or less, more preferably 20% by mass or more and 50% by mass or less. The proportion of each constitutional unit can be measured by nuclear magnetic resonance (NMR).

The polyolefin to be modified by grafting is, for example, a polymer of the olefin and may be a homopolymer or a copolymer of the olefin. Specific examples thereof include polyethylene, polypropylene, polybutene, poly-4-methyl-1-pentene, and copolymers of ethylene and an α-olefin with 3 or more and 20 or less carbon atoms. The graft-modified copolymer is a copolymer of the olefin and a polar monomer.

The polar monomer (graft monomer) for use in the graft modification may be the polar monomer described above and is preferably at least one selected from unsaturated carboxylic acids and derivatives thereof.

The proportion of a constitutional unit derived from the polar monomer (graft monomer) in the graft-modified product is preferably 0.01% by mass or more and 10.0% by mass or less, more preferably 0.05% by mass or more and 5.0% by mass or less. The proportion of each constitutional unit can be measured by NMR.

In one embodiment, the modified polyolefins are acid-modified polyolefins. The acid-modified polyolefins are described in detail later.

The modified polyolefins may be produced by a known method, for example, a method for radically copolymerizing an olefin and a polar monomer or a method for grafting a polar monomer to a main chain of a polyolefin or the copolymer in the presence of a radical initiator, such as an organic peroxide or an azo compound.

The copolymers and polyolefins can be produced by a known method, for example, by using a titanium catalyst, a vanadium catalyst, a metallocene catalyst, or the like. A polar monomer is grafted to a main chain of a polyolefin or the copolymer, for example, by a known graft polymerization method, such as a solution method or a melt-kneading method.

The modified polyolefins preferably have a weight-average molecular weight of 8,000 or more and 200,000 or less, more preferably 10,000 or more and 150,000 or less, based on polystyrene standards, measured by gel permeation chromatography (GPC).

The ionomers are cross-linked products of a polymer and a metal ion, preferably cross-linked products of an acid-modified polyolefin and a metal ion. In one embodiment, the ionomers are polymers in which free carboxy groups in the molecular structure are fully or partially neutralized with a metal ion.

Examples of the acid-modified polyolefin include a copolymer of an olefin and at least one selected from unsaturated carboxylic acids and derivatives thereof, and a graft-modified product of a polyolefin or the copolymer modified with at least one selected from unsaturated carboxylic acids and derivatives thereof. The olefin, unsaturated carboxylic acids and derivatives thereof, copolymer, polyolefin, and graft-modified product may be the specific examples described above.

In the acid-modified polyolefin, the proportion of a constitutional unit derived from an olefin is preferably 75% by mass or more and 90% by mass or less, and the proportion of a constitutional unit derived from at least one selected from unsaturated carboxylic acids and derivatives thereof is preferably 10% by mass or more and 25% by mass or less. The proportion of each constitutional unit can be measured by NMR.

Examples of the metal ion include alkali metal ions, such as a lithium ion, a sodium ion, and a potassium ion; and polyvalent metal ions, such as a calcium ion, a magnesium ion, a zinc ion, and an aluminum ion.

The ionomers preferably have a weight-average molecular weight of 8,000 or more and 200,000 or less, more preferably 10,000 or more and 150,000 or less, based on polystyrene standards, measured by GPC.

The ionomers are preferably cross-linked products of an olefin-(meth)acrylic acid copolymer and a metal ion, more preferably cross-linked products of an ethylene-(meth)acrylic acid copolymer and a metal ion.

The total modified polyolefin and ionomer content of the adhesive layer is preferably 20% by mass or more, more preferably 50% by mass or more and 100% by mass or less, still more preferably 70% by mass or more and 95% by mass or less.

The adhesive layer may further contain one or two or more thermoplastic resins other than the modified polyolefins and the ionomers. Examples of the thermoplastic resins include polyesters, vinyl resins, (meth)acrylic resins, urethane resins, cellulose resins, polyamides, polyolefins, polystyrene, and chlorinated resins thereof.

In one embodiment, the thermoplastic resin content other than the modified polyolefin and ionomer content of the adhesive layer is preferably 50% by mass or less, more preferably 40% by mass or less, still more preferably 30% by mass or less.

The adhesive layer preferably does not contain a chlorinated resin, such as a chlorinated polyolefin. This allows the adhesive layer to be dechlorinated, and a transfer product including the electrically conductive layer or metal-containing layer and the adhesive layer can therefore be used successfully as a constituent of an electronic component.

The adhesive layer may further contain one or two or more waxes. The use of the waxes can further improve adhesiveness to a transfer-receiving article, such as a paper substrate. Examples of the waxes include natural waxes, such as beeswax, spermaceti, Japan wax, rice bran wax, carnauba wax, candelilla wax, and montan wax, and synthetic waxes, such as paraffin wax, microcrystalline wax, oxidized wax, ester wax, and polyethylene wax.

In one embodiment, the wax content of the adhesive layer is preferably 50% by mass or less, more preferably 40% by mass or less, still more preferably 30% by mass or less, in terms of the balance between the transferability of the transfer layer, the adhesiveness of the adhesive layer to the electrically conductive layer, to the metal-containing layer, and to a transfer-receiving article, and the electrical conductivity of the electrically conductive layer and the specular gloss of the metal-containing layer.

In one embodiment, the adhesive layer further contains particles. This can improve the blocking resistance of the thermal transfer sheet and the foil release of the transfer layer and can improve the fine-line reproducibility of an electrically conductive pattern layer or a metal-containing pattern layer formed on a transfer-receiving article.

The separation layer can contain one or two or more types of particles.

The particles preferably have an average particle size of 0.1 μm or more and 10.0 μm or less, more preferably 0.5 μm or more and 5.0 μm or less, still more preferably 0.8 μm or more and 3.0 μm or less. In the present disclosure, the average particle size is a number-average particle size measured with a laser diffraction particle size distribution analyzer (SALD-2000J manufactured by Shimadzu Corporation) or a similar apparatus.

The particles may be inorganic particles or organic particles.

Examples of the inorganic particles include silica, talc, titanium oxide, and calcium carbonate. Examples of the organic particles include particles composed of a resin material, such as polyester, polyamide, polyolefin, vinyl resin, (meth)acrylic resin, imide resin, cellulose resin, styrene resin, polycarbonate, melamine resin, or fluoropolymer.

In one embodiment, the adhesive layer preferably has a particle content of 25% by mass or less, more preferably 2% by mass or more and 20% by mass or less, still more preferably 5% by mass or more and 15% by mass or less, still more preferably 5% by mass or more and 10% by mass or less. This can further improve the blocking resistance of the thermal transfer sheet, the foil release of the transfer layer, and the fine-line reproducibility of the electrically conductive pattern layer or the metal-containing pattern layer.

In one embodiment, the adhesive layer contains one or two or more electrically conductive materials. This can reduce the electrical resistance of the adhesive layer of the thermal transfer sheet and form an electrically conductive layer with high electrical conductivity. Examples of the electrically conductive materials include carbon black, tin oxide, indium oxide, zinc oxide, titanium oxide, potassium titanate, and electrically conductive polymers.

In one embodiment, the electrically conductive material content of the adhesive layer is preferably 0.1% by mass or more and 50% by mass or less, more preferably 1% by mass or more and 30% by mass or less. This can reduce the electrical resistance of the adhesive layer of the thermal transfer sheet and form an electrically conductive layer with high electrical conductivity.

The adhesive layer may contain one or two or more additive agents. Examples of the additive agents include a plasticizer, an antistatic agent, an ultraviolet absorber, and a dispersant.

An adhesive layer containing at least one component selected from a modified polyolefin and an ionomer has high adhesiveness to an electrically conductive layer, a metal-containing layer, and a transfer-receiving article even without using a chlorinated resin, such as a chlorinated polyolefin. This allows the adhesive layer to be dechlorinated, and a transfer product including the electrically conductive layer or metal-containing layer and the adhesive layer can therefore be used successfully as a constituent of an electronic component.

In one embodiment, the chlorine content of the entire transfer layer is preferably 900 ppm or less according to the standards of Japan Electronics Packaging and Circuits Association (JPCA) or International Electrotechnical Commission (IEC).

The adhesive layer preferably has a thickness of 0.1 μm or more and 5.0 μm or less, more preferably 0.3 μm or more and 3.0 μm or less, still more preferably 0.5 μm or more and 2.0 μm or less. This can further improve the transferability of the transfer layer of the thermal transfer sheet and the fine-line reproducibility of an electrically conductive pattern layer or a metal-containing pattern layer formed on a transfer-receiving article.

The adhesive layer can be formed, for example, by dispersing or dissolving the above components in water or an appropriate organic solvent to prepare a coating liquid, applying the coating liquid by the coating method described above to an electrically conductive layer or a metal-containing layer to form a coating film, and drying the coating film. In the preparation of the coating liquid, from the perspective of stabilization in a liquid state, an aqueous dispersion of a modified polyolefin is preferably used when the modified polyolefin is used, and an aqueous dispersion of an ionomer is preferably used when the ionomer is used.

<Anchor Coat Layer>

In one embodiment, the thermal transfer sheet includes an anchor coat layer between the substrate and the release layer. This can improve the adhesion between the substrate and the release layer and can further improve the transferability, such as the foil release, of the transfer layer.

In one embodiment, the anchor coat layer contains one or two or more resin materials. Examples of the resin materials include polyesters, polyamides, polyolefins, vinyl resins, vinyl acetal resins, (meth)acrylic resins, imide resins, urethane resins, epoxy resins, cellulose resins, styrene resins, polycarbonates, and ionomers.

The anchor coat layer may contain one or two or more additive agents. Examples of the additive agents include filler, a plasticizer, an antistatic agent, an ultraviolet absorber, organic particles, inorganic particles, and a dispersant.

The anchor coat layer preferably has a thickness of 0.1 μm or more and 1.0 μm or less, more preferably 0.2 μm or more and 0.5 μm or less. This can further improve the adhesion between the substrate and the release layer.

The anchor coat layer can be formed, for example, by dispersing or dissolving the above components in water or an appropriate organic solvent to prepare a coating liquid, before forming the release layer applying the coating liquid to a substrate by the coating method described above to form a coating film, and drying the coating film.

<Back Layer>

In one embodiment, the thermal transfer sheet includes a back layer on the surface of the substrate opposite the transfer layer. This can reduce the occurrence of sticking and wrinkling due to heating during thermal transfer.

In one embodiment, the back layer contains one or two or more resin materials. Examples of the resin materials include vinyl resins, vinyl acetal resins, polyesters, polyamides, polyolefins, (meth)acrylic resins, styrene resins, urethane resins, cellulose resins, and phenolic resins.

In one embodiment, the back layer contains one or two or more isocyanate compounds. Examples of the isocyanate compounds include xylene diisocyanate, toluene diisocyanate, isophorone diisocyanate, and hexamethylene diisocyanate.

The back layer may contain one or two or more additive agents. Examples of the additive agents include filler, a plasticizer, an antistatic agent, an ultraviolet absorber, organic particles, inorganic particles, a release agent, and a dispersant.

The back layer has a thickness of, for example, 0.1 μm or more and 3.0 μm or less.

The back layer can be formed, for example, by dispersing or dissolving the above components in water or an appropriate organic solvent to prepare a coating liquid, applying the coating liquid by the coating method described above to the substrate to form a coating film, and drying the coating film.

[Combination of Thermal Transfer Sheet and Transfer-Receiving Article]

A combination in the present disclosure is a combination of a thermal transfer sheet according to the present disclosure and a transfer-receiving article. The thermal transfer sheet is described above and is not described here.

The transfer-receiving article is, for example, a paper substrate or the resin film described above. Examples of the paper substrate include high-quality paper, plain paper, art paper, coated paper, resin-coated paper, cast-coated paper, paperboard, synthetic paper, and impregnated paper. The transfer-receiving article may be a laminate including two or more types of paper substrates, a laminate including two or more types of resin films, or a laminate including one or more types of paper substrates and one or more types of resin films.

The surface of a transfer-receiving article to which the transfer layer is transferred preferably has a smoothness of 1000 seconds or more, more preferably 1500 seconds or more, still more preferably 1700 seconds or more or 2000 seconds or more, still more preferably 2500 seconds or more, particularly preferably 3000 seconds or more. The upper limit of the smoothness is, but not limited to, for example, 20000 seconds, 10000 seconds, 6000 seconds, or 5000 seconds. A smoothness of 6000 seconds or less tends to result in higher transferability. The smoothness is Oken type smoothness measured in accordance with JIS P 8155.

A thermal transfer sheet according to the present disclosure has high transferability even to a transfer-receiving article with low smoothness. In one embodiment, the electrically conductive layer transferred and formed has fewer cracks and high electrical conductivity. Thus, an electrically conductive layer, particularly an electrically conductive pattern layer, with high electrical conductivity can be formed. In one embodiment, the metal-containing layer transferred and formed has fewer cracks and high specular gloss.

To further improve the transferability, electrical conductivity, or specular gloss, the transfer-receiving article is preferably a paper substrate or a PET film with the smoothness described above, more preferably a paper substrate or a PET film with a smoothness of 1700 seconds or more or 2000 seconds or more. In one embodiment, a coated paper or a PET film with the smoothness described above is preferred, and a coated paper or PET with a smoothness of 1700 seconds or more or 2000 seconds or more is more preferred.

[Method for Producing Thermal Transfer Sheet]

A method for producing a thermal transfer sheet according to the present disclosure includes the steps of
preparing a substrate, and
forming a transfer layer on the substrate, the transfer layer including an electrically conductive layer or metal-containing layer and an adhesive layer.

The adhesive layer contains at least one component selected from a modified polyolefin and an ionomer. The electrically conductive layer or the metal-containing layer constitutes a surface layer on the substrate side of the transfer layer.

In one embodiment, a method for producing a thermal transfer sheet according to the present disclosure includes the step of forming a release layer on a substrate. In this case, a transfer layer is formed on the release layer. In one embodiment, a release layer is formed on the surface of an anchor coat layer on a substrate on which the anchor coat layer is formed.

In one embodiment, the step of forming a transfer layer includes the steps of forming an electrically conductive layer or a metal-containing layer on a substrate or on a release layer and forming an adhesive layer on the electrically conductive layer or on the metal-containing layer.

In one embodiment, a method for producing a thermal transfer sheet further includes the step of forming a back layer on the surface of the substrate on which the transfer layer is provided or on the opposite surface of the substrate.

A method for forming each layer and the like are described in detail above.

[Method for Producing Transfer Product]

A method for producing a transfer product according to the present disclosure includes the steps of
preparing a thermal transfer sheet according to the present disclosure and a transfer-receiving article (a preparation step) and
thermally transferring a transfer layer of the thermal transfer sheet onto the transfer-receiving article (a transfer step).

<Preparation Step>

A thermal transfer sheet can be produced by the method described above.

The transfer-receiving article is described in detail above.

<Transfer Step>

A method for producing a transfer product according to the present disclosure includes the step of thermally transferring at least part of a transfer layer from a thermal transfer sheet onto a transfer-receiving article. Thus, in one embodiment, an electrically conductive layer, particularly an electrically conductive pattern layer, with high electrical conductivity can be formed on a transfer-receiving article. Also, in one embodiment, a metal-containing layer, particularly a metal-containing pattern layer, such as a metal-containing nonconductive pattern layer, with high specular gloss can be formed on a transfer-receiving article.

The electrically conductive pattern layer is, for example, a wiring layer or an antenna wire. In the transfer step, at least part of the transfer layer may be thermally transferred from the thermal transfer sheet onto the transfer-receiving article to form not only a wiring layer or an antenna wire but also an image composed of a letter, a pattern, a symbol, or a combination thereof.

More specifically, the transfer layer of the thermal transfer sheet is brought into contact with the surface of the transfer-receiving article, and a region of the thermal transfer sheet corresponding to the shape of a desired electrically conductive pattern or metal-containing pattern layer is then heated to transfer the transfer layer of the region onto the transfer-receiving article. In this manner, the electrically conductive pattern layer or the metal-containing pattern layer can be formed on the transfer-receiving article.

In one embodiment, the transfer step can be performed by placing the thermal transfer sheet on the transfer-receiving article, passing the thermal transfer sheet between a thermal head and a platen roller of a thermal transfer printer, and heating the thermal transfer sheet with the thermal head.

A thermal transfer sheet according to the present disclosure can be used to stably form an electrically conductive pattern layer or a metal-containing pattern layer on a transfer-receiving article by thermal transfer. According to the present disclosure, an electrically conductive pattern layer or a metal-containing pattern layer can be formed on a transfer-receiving article only by a dry process, for example, without photolithography and etching.

The transfer layer or the electrically conductive layer transferred onto a transfer-receiving article preferably has a surface electrical resistance of less than 10,000Ω, more preferably less than 1,000Ω, still more preferably less than 100Ω. Although the surface electrical resistance is preferably as low as possible, the lower limit thereof may be 1.0×10⁻³Ω in one embodiment. The surface electrical resistance can be measured by a method described in the Examples.

The present disclosure relates to, for example, the following [1] to [13]:
[1] A thermal transfer sheet including a substrate and a transfer layer on the substrate in this order in the thickness direction, the transfer layer being peelable by thermal transfer, wherein the transfer layer includes an electrically conductive layer or metal-containing layer and an adhesive layer, the adhesive layer contains at least one component selected from a modified polyolefin and an ionomer, and the electrically conductive layer or the metal-containing layer constitutes a surface layer on the substrate side of the transfer layer.
[2] The thermal transfer sheet according to [1], wherein the modified polyolefin is at least one selected from copolymers of an olefin and a polar monomer, and graft-modified products of a polyolefin or the copolymer modified with a polar monomer.
[3] The thermal transfer sheet according to [1] or [2], wherein the modified polyolefin is at least one selected from ethylene-(meth)acrylic acid copolymers and amine salts thereof, propylene-(meth)acrylic acid copolymers and amine salts thereof, and ethylene-vinyl acetate copolymers.
[4] The thermal transfer sheet according to any one of [1] to [3], wherein the ionomer is a cross-linked product of an acid-modified polyolefin and a metal ion.
[5] The thermal transfer sheet according to any one of [1] to [4], wherein the adhesive layer has a total modified polyolefin and ionomer content of 20% by mass or more.
[6] The thermal transfer sheet according to any one of [1] to [5], wherein the adhesive layer has a thickness of 0.1 μm or more and 5.0 μm or less.
[7] The thermal transfer sheet according to any one of [1] to [6], wherein the electrically conductive layer is a metallized layer, and the metal-containing layer is a metal-pigment-containing layer.
[8] The thermal transfer sheet according to [7], wherein the metallized layer is an aluminum-deposited layer or a copper-deposited layer.
[9] The thermal transfer sheet according to any one of [1] to [8], further comprising a release layer between the substrate and the transfer layer.
[10] The thermal transfer sheet according to [9], wherein the release layer contains a silicone resin.
[11] The thermal transfer sheet according to any one of [1] to [10], wherein the thermal transfer sheet is used to form an electrically conductive pattern layer.
[12] A combination of the thermal transfer sheet according to any one of [1] to [11] and a transfer-receiving article.
[13] The combination according to [12], wherein the transfer-receiving article is a paper substrate or a poly(ethylene terephthalate) film with an Oken type smoothness of 1700 seconds or more measured in accordance with JIS P 8155.
[14] A method for producing a thermal transfer sheet, including the steps of: preparing a substrate; and forming a transfer layer on the substrate, the transfer layer including an electrically conductive layer or metal-containing layer and an adhesive layer, wherein the adhesive layer contains at least one component selected from a modified polyolefin and an ionomer, and the electrically conductive layer or the metal-containing layer constitutes a surface layer on the substrate side of the transfer layer.
[15] A method for producing a transfer product, including the steps of: preparing the thermal transfer sheet according to any one of [1] to [11] and a transfer-receiving article; and thermally transferring the transfer layer of the thermal transfer sheet onto the transfer-receiving article.

### EXAMPLES

Although a thermal transfer sheet according to the present disclosure is further described in the following examples, a thermal transfer sheet according to the present disclosure is not limited to these examples. In the following description, the amounts shown in Tables 1 and 2, except for the solvent, are numerical values based on the solid content.

### Example 11

An coating liquid with the following composition for an anchor coat layer was applied to one surface of a PET film with a thickness of 6 μm and was dried to form an anchor coat layer with a thickness of 0.3 μm. A coating liquid with the following composition for a release layer was applied to the anchor coat layer and was dried to form a release layer with a thickness of 0.65 μm. The laminate thus formed was stored in a high-temperature environment for a certain period. An aluminum (AL) deposited layer with a thickness of 90 nm was formed on the release layer by a PVD method. A coating liquid with the following composition for an adhesive layer was applied to the aluminum-deposited layer and was dried to form an adhesive layer with a thickness of 1.0 μm. In Example 1, the transfer layer is composed of the aluminum-deposited layer and the adhesive layer. A coating liquid with the following composition for a back layer was applied to the surface of the PET film opposite the transfer layer and was dried to form a back layer with a thickness of 0.15 μm. A thermal transfer sheet was prepared in this manner.

<Coating Liquid for Anchor Coat Layer>

| | |
|---|---|
| Urethane resin (Hydran (registered trademark) | 78.8 parts |
| AP-40N manufactured by DIC corporation) | by mass |
| Epoxy resin (Watersol (registered trademark) | 16.8 parts |
| WSA-950 manufactured by DIC corporation) | by mass |
| Antistatic agent (aquaPASS (registered trademark) -01x | 4.4 parts |
| manufactured by Mitsubishi Chemical Corporation) | by mass |
| Ion-exchanged water | 300 parts |
| | by mass |
| Solvent (Solmix (registered trademark) A-11 | 1200 parts |
| manufactured by Japan Alcohol Trading Co., Ltd.) | by mass |

<Coating Liquid for Release Layer>

| | |
|---|---|
| Silsesquioxane with epoxy group (Compoceran | 18 parts |
| (registered trademark) SQ502-8 manufactured by | by mass |
| Arakawa Chemical Industries, Ltd.) | |
| Curing catalyst (Celtop (registered trademark) | 1.6 parts |
| CAT-A, manufactured by Daicel Chemical Industries, | by mass |
| Ltd., aluminum catalyst) | |
| Urethane-modified polyester (Vylon (registered | 0.8 parts |
| trademark) UR-1700 manufactured by Toyobo Co., Ltd.) | by mass |
| Toluene | 20 parts |
| | by mass |
| Methyl ethyl ketone (MEK) | 60 parts |
| | by mass |

<Coating Liquid for Adhesive Layer>

| | |
|---|---|
| Modified polyolefin (Aquatex (registered trademark) | 100 parts by mass |
| AC-3100 manufactured by Japan Coating Resin | |
| Corporation, an aqueous dispersion of an ethylene- | |
| methacrylic acid copolymer) | |
| Water | 450 parts by mass |
| Isopropyl alcohol (IPA) | 450 parts by mass |

<Coating Liquid for Back Layer>

| | | |
|---|---|---|
| Styrene-acrylonitrile copolymer | 11 | parts by mass |
| Linear saturated polyester | 0.3 | parts by mass |
| Zinc stearyl phosphate | 6 | parts by mass |
| Melamine resin powder | 3 | parts by mass |
| MEK | 80 | parts by mass |

### Examples 2 to 14 and Comparative Examples 1 to 3

A thermal transfer sheet was prepared in the same manner as in Example 1 except that the modified polyolefin in the coating liquid for an adhesive layer and the thickness of the adhesive layer were changed as shown in Table 1 or 2.

### Example 15

A thermal transfer sheet was prepared in the same manner as in Example 1 except that the composition of the coating liquid for a release layer was changed as described below.

<Coating Liquid for Release Layer>

| | |
|---|---|
| Silicone-modified acrylic resin (Celtop (registered | 18 parts |
| trademark) 226 manufactured by Daicel Chemical | by mass |
| Industries, Ltd.) | |
| Curing catalyst (Celtop (registered trademark) CAT-A, | 1.6 parts |
| manufactured by Daicel Chemical Industries, Ltd., | by mass |
| aluminum catalyst) | |
| Toluene | 40 parts |
| | by mass |
| MEK | 40 parts |
| | by mass |

### Example 161

A thermal transfer sheet was prepared in the same manner as in Example 1 except that an aluminum (AL) deposited layer with a thickness of 100 nm was formed on the release layer by the PVD method.

### Example 171

A thermal transfer sheet was prepared in the same manner as in Example 1 except that a copper (Cu) deposited layer with a thickness of 100 nm was formed on the release layer by the PVD method.

### Example 181

A thermal transfer sheet was prepared in the same manner as in Example 1 except that a coating liquid with the following composition for a metal-pigment-containing layer was applied and dried on the release layer to form a metal-pigment-containing layer with a thickness of 2 μm.

<Coating Liquid for Metal-Pigment-Containing Layer>

| | |
|---|---|
| Aluminum pigment (FD-5060 manufactured by Asahi Kasei | 20 parts |
| Corporation, median diameter (D50) 6 μm, hiding power | by mass |
| 3.4, non-leafing type) | |
| Vinyl chloride-vinyl acetate copolymer (Solbin (registered | 20 parts |
| trademark) CNL manufactured by Nissin Chemical Industry | by mass |
| Co., Ltd.) | |
| MEK | 30 parts |
| | by mass |
| Toluene | 30 parts |
| | by mass |

### Examples 19 and 20

A thermal transfer sheet was prepared in the same manner as in Example 17 except that the modified polyolefin in the coating liquid for an adhesive layer was changed as described in Table 2.

The constituents of the adhesive layer used in the examples and comparative examples are described below.

Modified Polyolefin
Modified polyolefin (AC-3100): Aquatex (registered trademark) AC-3100 (manufactured by Japan Coating Resin Corporation, an aqueous dispersion of an ethylene-methacrylic acid copolymer, solid concentration 44.5%)
Modified polyolefin (EC-3500): Aquatex (registered trademark) EC-3500 (manufactured by Japan Coating Resin Corporation, an aqueous dispersion of an ethylene-vinyl acetate copolymer, solid concentration 50%)
Modified polyolefin (TD-4010): Arrowbase (registered trademark) TD-4010 (manufactured by Unitika Ltd., an aqueous dispersion of an amine neutralized product of a propylene-acrylic acid copolymer, solid concentration 25%)
Modified polyolefin (L): Zaikthene (registered trademark) L (manufactured by Sumitomo Seika Chemicals Company, Limited., an aqueous dispersion of an ethylene-acrylic acid copolymer, solid concentration 25%)
Modified polyolefin (S3121): Hytec S series (registered trademark) S3121 (manufactured by Toho Chemical Industry Co., Ltd., an aqueous dispersion of an ethylene-acrylic acid copolymer, solid concentration 25%)

Ionomer
Ionomer (S100): Chemipearl (registered trademark) S100 (manufactured by Mitsui Chemicals, Inc., an aqueous dispersion of an ethylene-methacrylic acid copolymer ionomer, solid concentration 27%)
Ionomer (S300): Chemipearl (registered trademark) S300 (manufactured by Mitsui Chemicals, Inc., an aqueous dispersion of an ethylene-methacrylic acid copolymer ionomer, solid concentration 27%)

Particles
Particles (S12): Epostar (registered trademark) S12 (Nippon Shokubai Co., Ltd., a melamine-formaldehyde condensate, particle size 1.2 μm)

Wax
Wax (WE95): carnauba wax WE95
   (manufactured by Konishi Co., Ltd., aqueous dispersion, solid concentration 40%)

Polyester
Polyester (MD1930): Vylonal (registered trademark) MD1930
   (manufactured by Toyobo Co., Ltd., an aqueous dispersion of a polyester, solid concentration 31%)

[Evaluation of Transferability]

The thermal transfer sheets prepared in the examples and comparative examples and a label printer “Zebra1 40xi4” manufactured by Zebra Co., Ltd. serving as a printer were used to form a solid image and a linear pattern image with a length of 75 mm and a width of 2.5 mm on a transfer-receiving article at a printing speed of 4 inch per second (IPS) and at a printing energy of 30, thereby preparing a transfer product. A transfer layer on the transfer-receiving article was visually observed and was examined on the basis of the following evaluation criteria. Tables 1 and 2 show the results.

The following transfer-receiving articles were used.
A label with a smoothness of 5280 seconds,
   material: coated paper, label thickness: 90 μm, total thickness: 150 μm
A label with a smoothness of 4320 seconds,
   material: coated paper, label thickness: 80 μm, total thickness: 126 μm
A label with a smoothness of 3075 seconds,
   material: coated paper, label thickness: 80 μm, total thickness: 176 μm
A label with a smoothness of 1780 seconds,
   material: PET, label thickness: 72 μm, total thickness: 150 μm
A label with a smoothness of 8610 seconds,
   material: PET, label thickness: 73 μm, total thickness: 140 μm

### (Evaluation Criteria)

In the solid image,
A: there is no tailing or blurring, and high transferability is exhibited.
B: transfer is possible, but tailing occurs partially.
C: transfer is possible, but a printing defect, such as blurring, occurs partially.
D: transfer is impossible.

The smoothness of a transfer-receiving article, such as a coated paper, was Oken type smoothness measured in accordance with JIS P 8155 and was measured with an Oken type air permeability smoothness tester (model EB165, manufactured by Asahi Seiko Co., Ltd.).

[Evaluation of Electrical Conductivity]

The surface electrical resistance on the transfer layer side of the linear pattern image formed in the evaluation of transferability was measured with a digital tester “kaise DMM KU-11” (manufactured by Kaise Corporation, + terminal, measurable range: 0.1 to 2,000,000Ω) and was evaluated on the basis of the following evaluation criteria. Tables 1 and 2 show the results.

### (Evaluation Criteria)

A: A surface electrical resistance of less than 100Ω.
B: A surface electrical resistance of 100Ω or more and less than 1,000Ω.
C: A surface electrical resistance of 1,000Ω or more and less than 10,000Ω.
D: no electrical conductivity.
-: the evaluation was impossible because transfer was impossible.

[Fine-Line Reproducibility Evaluation 1]

The linear pattern image formed in the evaluation of transferability was examined on the basis of the following evaluation criteria. Tables 1 and 2 show the results.

### (Evaluation Criteria)

In the linear pattern image,
A: there is no tailing or blurring, and high fine-line reproducibility is exhibited.
B: tailing or blurring occurs partially.
-: the evaluation was impossible because transfer was impossible.

[Fine-Line Reproducibility Evaluation 2]

The evaluation was performed on the basis of the following evaluation criteria under the same conditions as in the evaluation of transferability except that the pattern image in the evaluation of transferability was changed to a linear pattern image with a length of 75 mm and a width of 1.5 mm and that the transfer-receiving article was the label with a smoothness of 5280 seconds. Tables 1 and 2 show the results.

### (Evaluation Criteria)

In the linear pattern image,
A: there is no tailing or blurring, and high fine-line reproducibility is exhibited.
B: tailing or blurring occurs partially.
-: the evaluation was impossible because transfer was impossible.

[Evaluation of Blocking]

Two thermal transfer sheets formed in each of the examples and comparative examples were superimposed with the adhesive layer and the back layer facing each other, were loaded with 0.196 MPa, and were allowed to stand at 35° C. and at a relative humidity of 85% for 24 hours. After standing, the two thermal transfer sheets were separated and were examined on the basis of the following evaluation criteria. Tables 1 and 2 show the results.

### (Evaluation Criteria)

A: The sheets could be smoothly separated, and no abnormal transfer of the transfer layer to the back layer was observed.
B: There was a slight resistance to the separation of the sheets, but no abnormal transfer of the transfer layer to the back layer was observed.
C: Abnormal transfer of the transfer layer to the back layer was observed in a very small portion, but there was no problem as a product.
D: Abnormal transfer of the transfer layer to the back layer was observed in at least half of the area, and there was a problem as a product.

TABLE 1

| | | EX. 1 | EX. 2 | EX. 3 | EX. 4 | EX. 5 |
|---|---|---|---|---|---|---|
| Adhesive | Modified polyolefin (AC-3100) | 100 | 100 | — | — | — |
| layer | Modified polyolefin (EC-3500) | — | — | 100 | — | — |
| Amount | Modified polyolefin (TD-4010) | — | — | — | 100 | — |
| based on | Modified polyolefin (L) | — | — | — | — | — |
| solid (parts | Modified polyolefin (S3121) | — | — | — | — | — |
| by mass) | Ionomer (S100) | — | — | — | — | 100 |
| | Ionomer (S300) | — | — | — | — | — |
| | Particle (S12) | — | — | — | — | — |
| | Wax (WE95) | — | — | — | — | — |
| | Polyester (MD1930) | — | — | — | — | — |
| Adhesive | Thickness (μm) | 1.0 | 3.0 | 1.0 | 1.0 | 1.0 |
| layer | | | | | | |
| Electrically | Composition | Al | Al | Al | Al | Al |
| conductive | | deposition | deposition | deposition | deposition | deposition |
| layer | Thickness (nm) | 90 | 90 | 90 | 90 | 90 |

| Evaluation | | | | | | |
|---|---|---|---|---|---|---|
| 1. | Transferability to label (smoothness: 5280 seconds) | A | B | A | A | A |
| | Electrical conductivity for the above 1 | A | B | A | A | A |
| | Fine-line reproducibility 1 for the above 1 | A | B | A | A | A |
| | Fine-line reproducibility 2 for the above 1 | A | B | B | B | A |
| 2. | Transferability to label (smoothness: 4320 seconds) | A | B | A | A | A |
| | Electrical conductivity for the above 2 | A | A | A | A | A |
| | Fine-line reproducibility 1 for the above 2 | A | B | A | A | A |
| 3. | Transferability to label (smoothness: 3075 seconds) | A | B | A | A | A |
| | Electrical conductivity for the above 3 | A | A | A | A | A |
| | Fine-line reproducibility 1 for the above 3 | A | B | A | A | A |
| 4. | Transferability to label (smoothness: 1780 seconds) | A | B | A | A | A |
| | Electrical conductivity for the above 4 | B | B | B | B | B |
| | Fine-line reproducibility 1 for the above 4 | A | B | A | A | A |
| 5. | Transferability to label (smoothness: 8610 seconds) | C | C | C | C | C |
| | Electrical conductivity for the above 5 | B | B | B | B | B |
| | Fine-line reproducibility 1 for the above 5 | B | B | B | B | B |

| Blocking | | A | B | B | B | B |
|---|---|---|---|---|---|---|
| | | EX. 6 | EX. 7 | EX. 8 | EX. 9 | EX. 10 |
| Adhesive | Modified polyolefin (AC-3100) | — | — | 95 | 90 | 85 |
| layer | Modified polyolefin (EC-3500) | — | — | — | — | — |
| Amount | Modified polyolefin (TD-4010) | — | — | — | — | — |
| based on | Modified polyolefin (L) | — | — | — | — | — |
| solid (parts | Modified polyolefin (S3121) | — | — | — | — | — |
| by mass) | Ionomer (S100) | 70 | — | — | — | — |
| | Ionomer (S300) | — | 100 | — | — | — |
| | Particle (S12) | — | — | 5 | 10 | 15 |
| | Wax (WE95) | 30 | — | — | — | — |
| | Polyester (MD1930) | — | — | — | — | — |
| Adhesive | Thickness (μm) | 1.0 | 1.0 | 1.0 | 1.0 | 1.0 |
| layer | | | | | | |
| Electrically | Composition | Al | Al | Al | Al | Al |
| conductive | | deposition | deposition | deposition | deposition | deposition |
| layer | Thickness (nm) | 90 | 90 | 90 | 90 | 90 |

| Evaluation | | | | | | |
|---|---|---|---|---|---|---|
| 1. | Transferability to label (smoothness: 5280 seconds) | A | A | A | A | A |
| | Electrical conductivity for the above 1 | A | A | A | A | A |
| | Fine-line reproducibility 1 for the above 1 | A | A | A | A | A |
| | Fine-line reproducibility 2 for the above 1 | A | A | A | A | A |
| 2. | Transferability to label (smoothness: 4320 seconds) | A | A | A | A | A |
| | Electrical conductivity for the above 2 | A | A | A | A | A |
| | Fine-line reproducibility 1 for the above 2 | A | A | A | A | A |
| 3. | Transferability to label (smoothness: 3075 seconds) | A | A | A | A | A |
| | Electrical conductivity for the above 3 | A | A | A | A | A |
| | Fine-line reproducibility 1 for the above 3 | A | A | A | A | A |
| 4. | Transferability to label (smoothness: 1780 seconds) | A | A | A | A | A |
| | Electrical conductivity for the above 4 | B | B | B | B | B |
| | Fine-line reproducibility 1 for the above 4 | A | A | A | A | A |
| 5. | Transferability to label (smoothness: 8610 seconds) | C | C | C | C | C |
| | Electrical conductivity for the above 5 | B | B | B | B | B |
| | Fine-line reproducibility 1 for the above 5 | B | B | B | B | B |

| | | | | | |
|---|---|---|---|---|---|
| Blocking | B | B | A | A | A |

TABLE 2

| | | EX. 11 | EX. 12 | EX. 13 | EX. 14 | EX. 15 | EX. 16 | EX. 17 |
|---|---|---|---|---|---|---|---|---|
| Adhesive | Modified polyolefin (AC-3100) | 70 | 50 | 70 | 50 | 100 | 100 | 100 |
| layer | Modified polyolefin (EC-3500) | — | — | — | — | — | — | — |
| Amount | Modified polyolefin (TD-4010) | — | — | — | — | — | — | — |
| based on | Modified polyolefin (L) | — | — | — | — | — | — | — |
| solid (parts | Modified polyolefin (S3121) | — | — | — | — | — | — | — |
| by mass) | Ionomer (S100) | — | — | — | — | — | — | — |
| | Ionomer (S300) | — | — | — | — | — | — | — |
| | Particle (S12) | — | — | — | — | — | — | — |
| | Wax (WE95) | — | — | — | — | — | — | — |
| | Polyester (MD1930) | — | — | — | — | — | — | — |
| Adhesive | Thickness (μm) | 1.0 | 3.0 | 1.0 | 1.0 | 1.0 | 1.0 | 1.0 |
| layer | | | | | | | | |
| Electrically | Composition | Al | Al | Al | Al | Al | Al | Cu |
| conductive | | deposition | deposition | deposition | deposition | deposition | deposition | deposition |
| layer | Thickness (nm) | 90 | 90 | 90 | 90 | 90 | 100 | 100 |

| Evaluation | | | | | | | | |
|---|---|---|---|---|---|---|---|---|
| 1. | Transferability to label (smoothness: 5280 seconds) | A | A | A | A | A | A | A |
| | Electrical conductivity for the above 1 | A | A | A | A | A | A | A |
| | Fine-line reproducibility 1 for the above 1 | A | A | A | A | A | A | A |
| | Fine-line reproducibility 2 for the above 1 | A | B | A | B | A | A | A |
| 2. | Transferability to label (smoothness: 4320 seconds) | A | A | A | A | A | A | A |
| | Electrical conductivity for the above 2 | A | A | A | A | A | A | A |
| | Fine-line reproducibility 1 for the above 2 | A | A | A | A | A | A | A |
| 3. | Transferability to label (smoothness: 3075 seconds) | A | A | A | A | A | A | A |
| | Electrical conductivity for the above 3 | A | A | A | A | A | A | A |
| | Fine-line reproducibility 1 for the above 3 | A | A | A | A | A | A | A |
| 4. | Transferability to label (smoothness: 1780 seconds) | A | A | A | A | A | A | A |
| | Electrical conductivity for the above 4 | B | B | B | B | B | B | B |
| | Fine-line reproducibility 1 for the above 4 | A | A | A | A | A | A | A |
| 5. | Transferability to label (smoothness: 8610 seconds) | C | C | B | B | C | C | C |
| | Electrical conductivity for the above 5 | B | B | B | B | B | B | B |
| | Fine-line reproducibility 1 for the above 5 | B | B | B | B | B | B | B |

| | | | | | | | |
|---|---|---|---|---|---|---|---|
| Blocking | B | B | B | B | A | A | A |

| | | | | | Com. | Com. | Com. |
|---|---|---|---|---|---|---|---|
| | | EX. 18 | EX. 19 | EX. 20 | Ex. 1 | Ex. 2 | Ex. 3 |
| Adhesive | Modified polyolefin (AC-3100) | 100 | — | — | — | — | — |
| layer | Modified polyolefin (EC-3500) | — | — | — | — | — | — |
| Amount | Modified polyolefin (TD-4010) | — | — | — | — | — | — |
| based on | Modified polyolefin (L) | — | 100 | — | — | — | — |
| solid (parts | Modified polyolefin (S3121) | — | — | 100 | — | — | — |
| by mass) | Ionomer (S100) | — | — | — | — | — | — |
| | Ionomer (S300) | — | — | — | — | — | — |
| | Particle (S12) | — | — | — | — | — | — |
| | Wax (WE95) | — | — | — | 100 | 100 | — |
| | Polyester (MD1930) | — | — | — | — | — | 100 |
| Adhesive | Thickness (μm) | 1.0 | 1.0 | 1.0 | 3.0 | 1.0 | 1.0 |
| layer | | | | | | | |
| Electrically | Composition | Al-containing | Cu | Cu | Al | Al | Al |
| conductive | | layer | deposition | deposition | deposition | deposition | deposition |
| layer | Thickness (nm) | 2000 | 100 | 100 | 90 | 90 | 90 |

| Evaluation | | | | | | | |
|---|---|---|---|---|---|---|---|
| 1. | Transferability to label (smoothness: 5280 seconds) | A | A | A | D | D | A |
| | Electrical conductivity for the above 1 | D | A | A | — | — | A |
| | Fine-line reproducibility 1 for the above 1 | A | A | A | — | — | A |
| | Fine-line reproducibility 2 for the above 1 | A | A | A | — | — | A |
| 2. | Transferability to label (smoothness: 4320 seconds) | A | A | A | D | D | A |
| | Electrical conductivity for the above 2 | D | A | A | — | — | A |
| | Fine-line reproducibility 1 for the above 2 | A | A | A | — | — | B |
| 3. | Transferability to label (smoothness: 3075 seconds) | A | A | A | D | D | C |
| | Electrical conductivity for the above 3 | D | A | A | — | — | D |
| | Fine-line reproducibility 1 for the above 3 | A | A | A | — | — | B |
| 4. | Transferability to label (smoothness: 1780 seconds) | A | A | A | D | D | D |
| | Electrical conductivity for the above 4 | D | B | B | — | — | — |
| | Fine-line reproducibility 1 for the above 4 | A | A | A | — | — | — |
| 5. | Transferability to label (smoothness: 8610 seconds) | C | C | C | D | D | A |
| | Electrical conductivity for the above 5 | D | B | B | — | — | B |
| | Fine-line reproducibility 1 for the above 5 | B | B | B | — | — | B |

| | | | | | | |
|---|---|---|---|---|---|---|
| Blocking | A | A | A | B | B | B |

Those skilled in the art will appreciate that a thermal transfer sheet and the like according to the present disclosure are not limited to these examples, the examples and the specification only illustrate the principles of the present disclosure, various modifications and improvements may be made without departing from the gist and scope of the present disclosure, and all the modifications and improvements fall within the scope of the present disclosure for which protection is sought. Furthermore, the scope for which protection is sought by the present disclosure includes not only the claims but also equivalents thereof.

### REFERENCE SIGNS LIST

10 thermal transfer sheet
11 substrate
12 transfer layer
13 electrically conductive layer or metal-containing layer
14 adhesive layer
15 release layer
16 anchor coat layer
17 back layer

1. A thermal transfer sheet comprising a substrate and a transfer layer on the substrate in this order in a thickness direction, the transfer layer being peelable by thermal transfer,
wherein the transfer layer includes
an electrically conductive layer or a metal-containing layer, and
an adhesive layer, and
the adhesive layer contains at least one component selected from a modified polyolefin and an ionomer.

2. The thermal transfer sheet according to claim 1, wherein the modified polyolefin is at least one selected from copolymers of an olefin and a polar monomer, and graft-modified products of a polyolefin or the copolymer modified with a polar monomer.

3. The thermal transfer sheet according to claim 1, wherein the modified polyolefin is at least one selected from ethylene-(meth)acrylic acid copolymers and amine salts thereof, propylene-(meth)acrylic acid copolymers and amine salts thereof, and ethylene-vinyl acetate copolymers.

4. The thermal transfer sheet according to claim 1, wherein the ionomer is a cross-linked product of an acid-modified polyolefin and a metal ion.

5. The thermal transfer sheet according to claim 1, wherein the adhesive layer has a total modified polyolefin and ionomer content of 20% by mass or more.

6. The thermal transfer sheet according to claim 1, wherein the adhesive layer has a thickness of 0.1 μm or more and 5.0 μm or less.

7. The thermal transfer sheet according to claim 1, wherein the electrically conductive layer is a metallized layer, and the metal-containing layer is a metal-pigment-containing layer.

8. The thermal transfer sheet according to claim 7, wherein the metallized layer is an aluminum-deposited layer or a copper-deposited layer.

9. The thermal transfer sheet according to claim 1, further comprising a release layer between the substrate and the transfer layer.

10. The thermal transfer sheet according to claim 9, wherein the release layer contains a silicone resin.

11. The thermal transfer sheet according to claim 1, wherein the thermal transfer sheet is used to form an electrically conductive pattern layer.

12. A combination of the thermal transfer sheet according to claim 1 and a transfer-receiving article.

13. The combination according to claim 12, wherein the transfer-receiving article is a paper substrate or a poly(ethylene terephthalate) film with an Oken type smoothness of 1700 seconds or more measured in accordance with JS P 8155.

14. A method for producing a thermal transfer sheet, comprising the steps of:
preparing a substrate; and
forming a transfer layer on the substrate, the transfer layer including an electrically conductive layer or metal-containing layer and an adhesive layer,
wherein the adhesive layer contains at least one component selected from a modified polyolefin.

15. A method for producing a transfer product, comprising the steps of:
preparing the thermal transfer sheet according to claim 1 and a transfer-receiving article; and
thermally transferring the transfer layer of the thermal transfer sheet onto the transfer-receiving article.
